(19) United States
(12) Patent Application Publication
(10) Pub. No.: US 2021/0150845 A1
(43) Pub. Date: May 20, 2021

(54) GENERAL-PURPOSE COMPUTER CONTROL SYSTEM FOR AUTOMATIC VENDING MACHINE

(71) Applicant: EBN Technology Corp., New Taipei City (TW)

(72) Inventors: TZE-YANG LIU, New Taipei City (TW); SHENG-HSIUNG CHANG, New Taipei City (TW)

(21) Appl. No.: 16/686,166

(22) Filed: Nov. 17, 2019

(51) Int. Cl. G07F 17/00; G06F 21/60; H04W 12/00; G06Q 20/18

(52) U.S. Cl. CPC G07F 17/0014; G06F 21/602; G06Q 2220/00; G06Q 20/18; H04W 12/0013

(57) ABSTRACT

A general-purpose computer control system for an automatic vending machine, that includes: a general-purpose conversion and control module, a data integration conversion unit, an automatic vending machine control unit, a wireless transmission unit, an encryption protection unit, and a plurality of connection ports. On the general-purpose conversion and control module is disposed a first general-purpose connection end, for connecting to the automatic vending machine. Wherein, in the data integration conversion unit is disposed a central processing unit (CPU), to perform data connection and conversion between the CPU and the automatic vending machine control unit. The automatic vending machine control unit is used to control the operations inside the automatic vending machine. The wireless transmission unit is used to perform data transmission and verification for a remote end. The encryption protection unit is used to perform data encryption for the automatic vending machine.

### BACKGROUND OF THE INVENTION

### Field of the Invention

The preferred embodiment of the present invention relates to a control device for a vending machine, and in particular to a general-purpose computer control system for an automatic vending machine.

### The Prior Arts

Nowadays, in our industrialized society of rapid economic growth and development, most people have quite busy daily schedules, while keeping a quick tempo of life. As such, people do not have much time spared for purchasing the commodity required. To facilitate purchasing commodities, automatic vending machines are disposed in quite a lot of public places. In this respect, the automatic vending machine is able to sell various kinds of commodities, and it has the advantages of: not occupying too much space, being able to be moved dynamically to the key locations, without incurring labor cost. In addition, it is able to keep the prices of the commodities low, and it can be operated continuously for 24 hours, thus offering the customers convenience of purchasing items the whole day around.

In the early stage, the automatic vending machines are of a coin acceptor type. With the advent of intelligent vending machines, in addition to the coin operated payment and credit card payment, other payments such as OR code payment and mobile phone payment are also available, to provide further convenience to the customer.

However, regardless of the various payments of the old or new automatic vending machine, the designs of their internal controllers have not changed significantly. In certain case, the controller is made of a simple circuit board, or it is designed into a housing of outer shell. Therefore, for the automatic vending machines of different manufacturers, their controllers produced are quite different and not compatible to each other. As such, that causes difficulties in the maintenance of the existing automatic vending machine, and the design and development of new type of automatic vending machine.

For the new generation of automatic vending machines, it must have the capabilities of various types of payments, being able to be connected to a touch control screen to perform dynamic display. More importantly, it must have the capability of remote transmission, enciphered payment, data verification, enhanced anti-virus, and anti-hacking. However, the controller of the existing and conventional automatic vending machines is not sufficient to achieve these features.

Therefore, presently, the design and performance of the controller of the automatic vending machines is not quite satisfactory, and it leaves much room for improvement.

### SUMMARY OF THE INVENTION

In order to overcome the problems and drawbacks of the prior art, the preferred embodiment of the present invention provides a general-purpose computer control system for an automatic vending machine, that includes: a general-purpose conversion and control module, a data integration conversion unit, an automatic vending machine control unit, a wireless transmission verification unit, an encryption protection unit, and a plurality of connection ports; on the general-purpose conversion and control module is disposed a first general-purpose connection end, for connecting to the automatic vending machine.

In the data integration conversion unit is disposed a central processing unit (CPU), to perform data connection and conversion between the CPU and the automatic vending machine control unit.

The automatic vending machine control unit is used to control the operations inside the automatic vending machine.

The wireless transmission unit is used to perform data transmission and verification for a remote end.

The encryption protection unit is used to perform data encryption for the automatic vending machine.

The plurality of connection ports are connected to the automatic vending machine control unit inside the general-purpose conversion and control module; and are connected to a motor, a coin acceptor and a credit card machine disposed outside the general-purpose conversion and control module.

Further scope of the applicability of the present invention and embodiments thereof will become apparent from the detailed descriptions given hereafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

Embodiments of the present invention are described below, by way of example only, with reference to the accompanying drawings, in which:

FIG. 1 is a function block diagram for a general-purpose conversion and control module 10 according to the present invention;

FIG. 2 is a schematic diagram for the general-purpose conversion and control module configurable to be an intelligent computer, according to the present invention;

FIG. 3 is a schematic diagram for a general-purpose conversion and control module 10 configurable to be a computer insertion card interface of common gauge according to the present invention;

FIG. 4 is a flow chart of performing data encryption and anti-virus functions by a general-purpose conversion and control module according to the present invention; and

FIG. 5 is a schematic diagram for automatic vending machine control unit according to the Prior Art.

### DETAILED DESCRIPTION OF THE PREFERRED EMBODIMENT

The purpose, construction, features, functions and advantages of the present invention and its embodiments can be appreciated and understood more thoroughly through the following detailed descriptions with reference to the attached drawings.

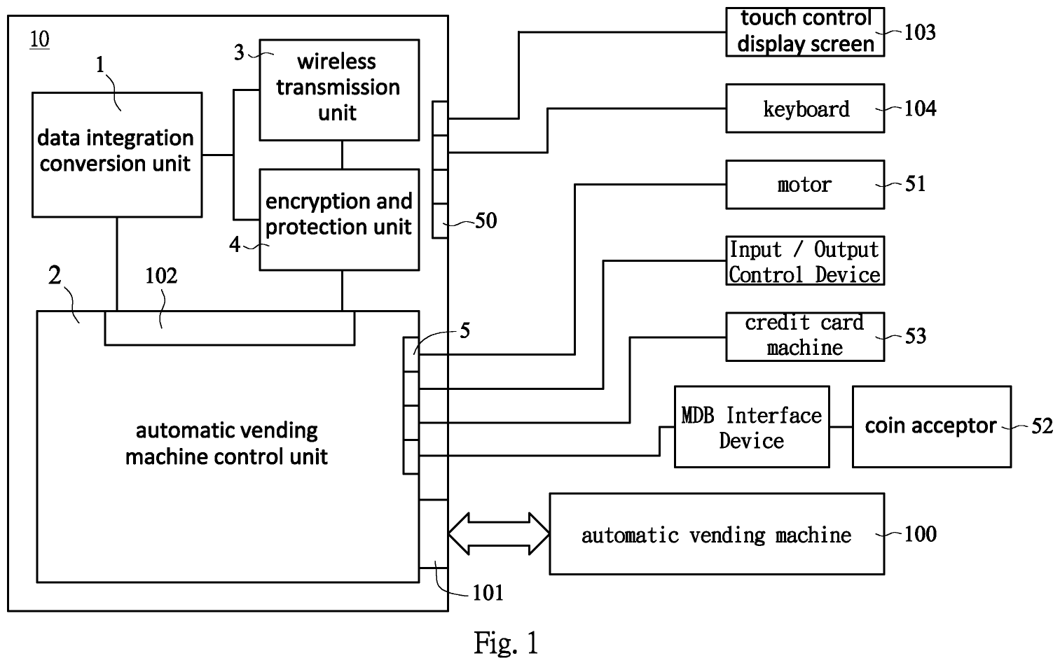

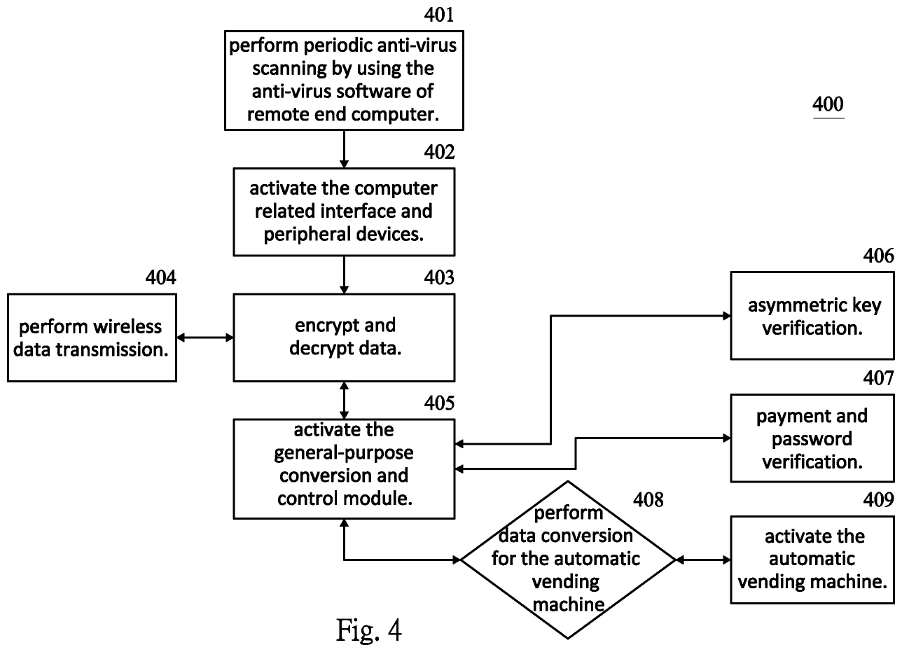

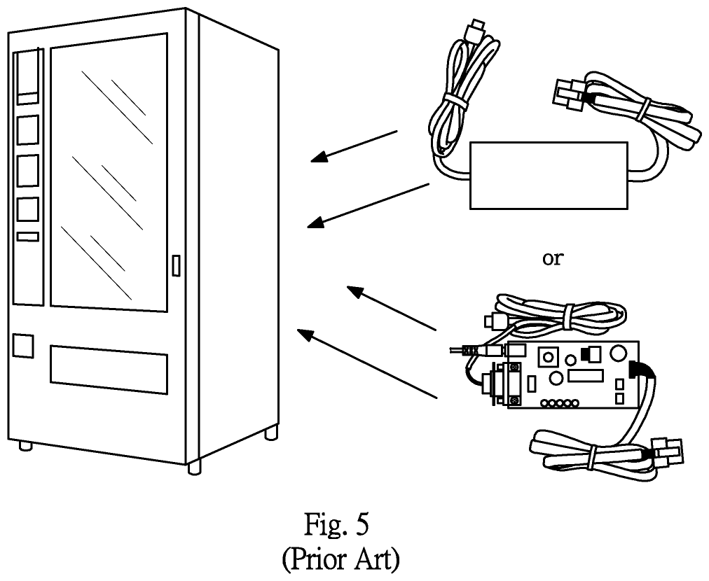

Refer to FIGS. 1 to 5 respectively for a function block diagram for a general-purpose conversion and control module 10 according to the present invention; for the general-purpose conversion and control module configurable to be an intelligent computer, according to the present invention; a schematic diagram for a general-purpose conversion and control module 10 configurable to be a computer insertion card interface of common gauge according to the present invention; a flow chart of performing data encryption and anti-virus functions by a general-purpose conversion and control module according to the present invention; and a schematic diagram for automatic vending machine control unit according to the Prior Art.

As shown in FIGS. 1-4, the preferred embodiment of the present invention provides a general-purpose computer control system for an automatic vending machine, that includes: a general-purpose conversion and control module 10, a data integration conversion unit 1, an automatic vending machine control unit 2, a wireless transmission unit 3, an encryption and protection unit 4, and a plurality of connection ports 5. On the general-purpose conversion and control module 10 is disposed a first general-purpose connection end 101, for connecting to the automatic vending machine 100.

On the general-purpose conversion and control module 10 is disposed a first general-purpose connection end 101 for connecting to an automatic vending machine 100. The general-purpose conversion and control module 10 is configurable to be an intelligent computer, but the present invention is not limited to this. A second general-purpose connection end 102 is disposed on the intelligent computer to be connected to the automatic vending machine control unit 2.

In the data integration conversion unit 1 is disposed a central processing unit (CPU), to perform data connection and conversion between the CPU and the automatic vending machine control unit 2.

The automatic vending machine control unit 2 is used to control the operations inside the automatic vending machine 100.

The wireless transmission unit 3 is used to perform data transmission and verification for a remote end. Preferably, the wireless transmission unit 3 is provided with encryption functions.

The encryption and protection unit 4 is used to provide data encryption for the automatic vending machine 100.

The plurality of connection ports 5, 50 are connected to the automatic vending machine control unit 2 inside the general-purpose conversion and control module 10; and are connected to a motor 51, a coin acceptor 52, and a credit card machine 53 disposed outside the general-purpose conversion and control module 10. The plurality of connection ports 5, 50 are connected to a touch control display screen 103 and a keyboard 104.

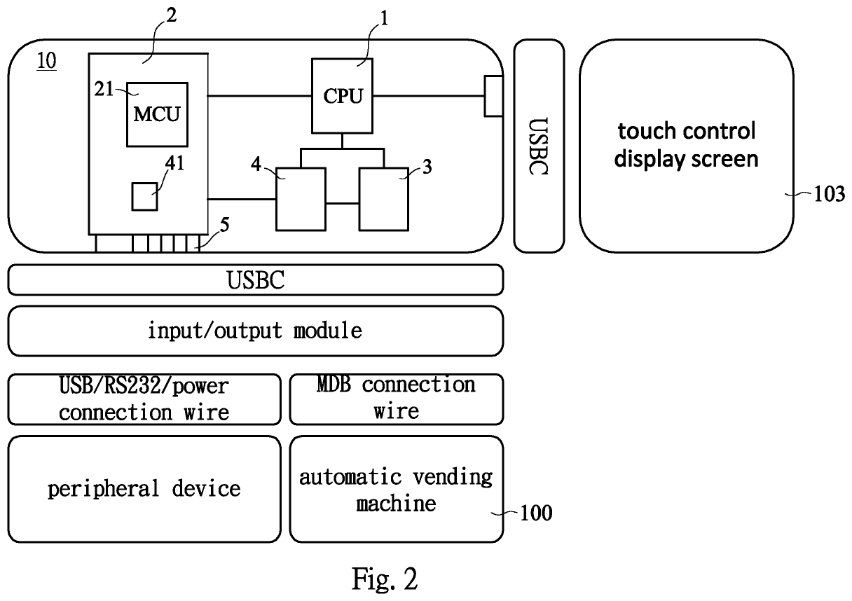

Preferably, as shown in FIG. 2, at least a crypto element IC 41 is disposed on the automatic vending machine control unit 2, but the present invention is not limited to this.

Preferably, at least a microcontroller unit (MCU) 21 is disposed in the automatic vending machine control unit 2, but the present invention is not limited to this. And two different data conversion ICs can also be provided (not shown).

Preferably, the wireless transmission unit 3 is one of the following: 3G, 4G, 5G wireless modules, a 433 MHz wireless module, and a Wi-Fi wireless network module.

Preferably, the intelligent computer is provided with an anti-virus software, an encryption software; and a network firewall software can also be provided, but the present invention is not limited to this.

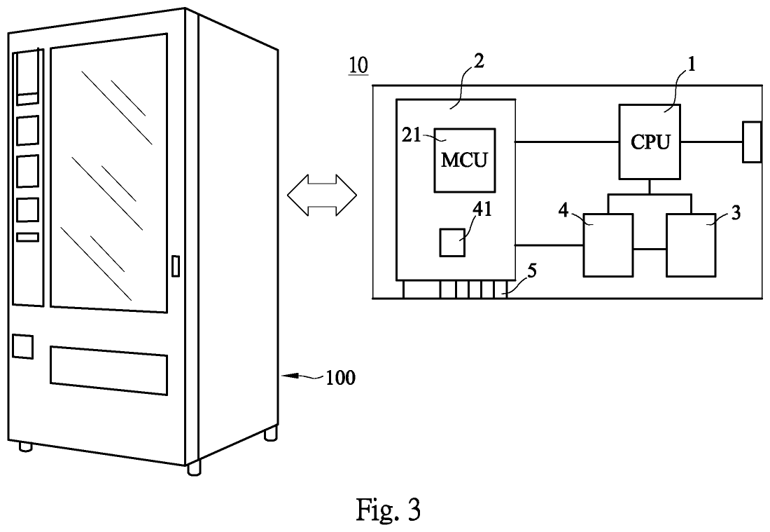

Preferably, as shown in FIGS. 1 and 2, the general-purpose conversion and control module 10 can be configurable to be an intelligent. Or, as shown in FIG. 3, the general-purpose conversion and control module 10 can be configurable to be a computer insertion card interface of common gauge, that it can be inserted into various different automatic vending machines 100 to perform its functions. Also, the automatic vending machine control unit 2 can be configurable to be a communication conversion and control card (not shown), so that it can be inserted into various automatic vending machines 100.

The steps of a method 400 for executing the present invention are as follows:

Step 401: perform periodic anti-virus scanning by using the anti-virus software of remote end computer.

Step 402, activate the computer related interface and peripheral devices.

Step 403: encrypt and decrypt data.

Step 404: perform wireless data transmission.

Step 405: activate the general-purpose conversion and control module.

Step 406: asymmetric key verification.

Step 407: payment and password verification.

Step 408 perform data conversion for the automatic vending machine.

Step 409: activate the automatic vending machine.

As such, the present invention can be used conveniently on different automatic vending machines 100, to be connected to a remote end to receive the data required, to fulfill the requirement of existing and advanced automatic vending machines 100, to control its payment and password verification.

As shown in FIGS. 1-5, compared with the existing technology, the present invention has the following advantages:

1. In the present invention, the general-purpose conversion and control module 10 can be installed easily and simply, and it can be connected to a touch control display screen 13 of various sizes, so that the new generation of automatic vending machine is able to provide better dynamic display effect.

2. Through using the present invention, the automatic vending machines of various manufacturers can be used compatibly, and that is advantageous for the maintenance of existing automatic vending machines, and the development of new types of automatic vending machines. In applications, it can save significantly the time and effort required for certification. Once passing through certification, the subsequent installation of the automatic vending machines, or replacements of spare parts of the automatic vending machines, no recertification is required. Also, the related encrypted payment does not need recertification.

3. The general-purpose conversion and control module 10 is provided with a crypto element IC41, plus the anti-virus software, the encryption software, and a network firewall software installed in the computer connected, that could improve significantly the functions and performance of the remote end transmission, encrypted payment, data verification, enhanced anti-virus, and anti-hiking, to increase effectively the safety of data transaction.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A general-purpose computer control system for an automatic vending machine, comprising: a general-purpose conversion and control module, a data integration conversion unit, an automatic vending machine control unit, a wireless transmission unit, an encryption protection unit, and a plurality of connection ports; on the general-purpose conversion and control module is disposed a first general-purpose connection end, for connecting to the automatic vending machine; wherein
in the data integration conversion unit is disposed a central processing unit (CPU), to perform data connection and conversion between the CPU and the automatic vending machine control unit;
the automatic vending machine control unit is used to control the operations inside the automatic vending machine;
the wireless transmission unit is used to perform data transmission a remote end;
the encryption protection unit is used to perform data encryption for the automatic vending machine; and
the plurality of connection ports are connected to the automatic vending machine control unit inside the general-purpose conversion and control module; and the plurality of connection ports are connected to a motor, a coin acceptor and a credit card machine disposed outside the general-purpose conversion and control module.

2. The general-purpose computer control system for the automatic vending machine as claimed in claim 1, wherein the wireless transmission and verification unit is one of the following: 3G, 4G, 5G wireless modules, a 433 MHz wireless module, and a Wi-Fi wireless network module.

3. The general-purpose computer control system for the automatic vending machine as claimed in claim 1, further comprising at least two different data conversion ICs on the automatic vending machine control unit.

4. The general-purpose computer control system for the automatic vending machine as claimed in claim 1, further comprising at least a microcontroller unit (MCU) on the automatic vending machine control unit.

5. The general-purpose computer control system for the automatic vending machine as claimed in claim 1, further comprising at least a crypto element IC on the automatic vending machine control unit.

6. The general-purpose computer control system for the automatic vending machine as claimed in claim 1, wherein the general-purpose conversion and control module is configurable to be an intelligent computer, and a second general-purpose connection end is disposed on the intelligent computer to be connected to the automatic vending machine control unit, the intelligent computer is connected to a touch control display screen or a keyboard.

7. The general-purpose computer control system for the automatic vending machine as claimed in claim 1, wherein the intelligent computer is provided with one of the following: an anti-virus software, an encryption software, and a network firewall software.

8. The general-purpose computer control system for the automatic vending machine as claimed in claim 1, wherein the general-purpose conversion and control module is configurable to be a computer insertion card interface of common gauge.
